(19) United States
(12) Patent Application Publication
(10) Pub. No.: US 2024/0113398 A1
(43) Pub. Date: Apr. 4, 2024

(54) MANUFACTURE OF COMPONENTS FOR BATTERIES

(71) Applicant: JAGUAR LAND ROVER LIMITED, Whitley, Conventry, Warwickshire (GB)

(72) Inventors: Connor LAVENDER-MOORE, Wolverhampton, West Midlands (GB); Steve JONES, Warwick, Warwickshire (GB); Debora MAZZETTA, Coventry, Warwickshire (GB); James THRIPPLETON, Stratford Upon Avon, Warwickshire (GB)

(21) Appl. No.: 18/277,056

(22) PCT Filed: Feb. 14, 2022
(86) PCT No.: PCT/EP2022/053462

§ 371 Date: Aug. 11, 2023

(30) Foreign Application Priority Data
Feb. 12, 2021 (GB) 2101959.1

(51) Int. Cl. H01M 50/514; H01M 50/213; H01M 50/249; H01M 50/507

(52) U.S. Cl. CPC H01M 50/514; H01M 50/213; H01M 50/249; H01M 50/507; H01M 2220/20

(57) ABSTRACT

The present invention provides a method of producing a set of mechanically connected cells (200), especially for use in a vehicle traction battery (704). The method comprises producing a plurality of rows of mechanically connected cells in a first jig, and subsequently connecting the cells together in a second jig. Advantageously, the method may substantially reduce the problem of tolerance stack associated with mechanically connected cells.

### TECHNICAL FIELD

The present invention relates generally to manufacture of components for batteries. In particular, but not exclusively, the invention relates to manufacture of sets of mechanically connected cells for vehicle traction batteries. Aspects of the invention relate to a method of manufacture of a set of mechanically connected cylindrical cells battery module, to a method of manufacture of a battery, to a battery module, to a battery pack, and to a vehicle.

### BACKGROUND

There has recently been increased interest in providing battery-powered vehicles, which has led to developments in vehicle battery, in particular vehicle traction battery, technology. It is generally desirable for vehicle batteries to provide high energy capacity and peak current output, whilst minimising the size and weight of the battery module and thus the vehicle.

Vehicle traction batteries often comprise one or more modules each containing a plurality of cells. It is generally desirable to package the cells into a battery module as densely as can safely be achieved, so as to maximise the energy and current capacity that can be provided within a given packaging volume.

In the manufacture of vehicle battery modules, it is important to ensure that all of the individual components of the module can be reliably made to the required dimensional tolerances.

It is an object of embodiments of the invention to at least mitigate one or more of the problems of the prior art.

### SUMMARY OF THE INVENTION

According to an aspect of the invention for which protection is sought, there is provided a method of manufacture of a set of mechanically connected cylindrical cells, the method comprising:
a) providing a first jig having a plurality of spaced apart cell location features, wherein each cell location feature is arranged to constrain a cylindrical cell placed therein such that the longitudinal axes of the cells in the location features are substantially parallel and coplanar;
b) placing a plurality of cylindrical cells in adjacent location features;
c) mechanically bonding adjacent cells with adhesive to produce a first row of cells;
d) repeating steps b)-c) to produce a second row of cells;
e) placing the first row of cells into a second jig such that the longitudinal axes of the cells in the first row are located in a first plane;
f) applying adhesive to one of the first and second rows of cells; and
g) placing the second row of cells into the second jig adjacent to the first row of cells, such that the longitudinal axes of the cells in the second row are located in a second plane parallel to the first plane, and such that the adhesive joins the first and second rows of cells. Advantageously, this method may substantially eliminate the problem of tolerance stack when producing a set of mechanically connected cylindrical cells.

It will be understood that the longitudinal axes may not be exactly parallel or coplanar. In particular, variations in the position of the cells relative to one another (and therefore the relative positions of their longitudinal axes) may arise from variations in the diameters of the cells, which may not be controlled to a very fine tolerance.

In an embodiment, the second jig comprises a first set of abutment features arranged to constrain the position of the first row of cells in the first plane and a second set of abutment features arranged to constrain the position of the second row of cells in the second plane. Advantageously, this ensures that each of the rows of cells are held at the required positions within the second jig.

In an embodiment, step b) comprises placing at least five cells in adjacent location features. This provides a set of mechanically connected cells having a plurality of rows of at least five cells. However, it will be understood that other numbers of cells in each row may be useful. For example, each row may comprise between three and ten cells, and the number of location features in step b) may correspond to the number of cells in each row. It is also feasible that different rows may comprise different numbers of cells.

Optionally, step d) comprises repeating steps b)-c) at least five times, to produce second, third, fourth, fifth and sixth rows of cells. This produces a set of mechanically connected cells comprising six rows of cells. However, it will be understood that other numbers of rows of cells may also be useful. For example, the set of mechanically connected cells may comprise between three and ten rows of cells.

In an embodiment the adjacent cell location features are spaced apart by a distance of less than the diameter of the cells, plus 1 mm. Optionally, the adjacent cell location features are spaced apart by a distance of less than the diameter of the cells, plus 0.5 mm. Preferably, the adjacent cell location features are spaced apart by a distance of the diameter of the cells plus 0.3 mm. In an embodiment, the adjacent cell location features are spaced apart by a distance of less than the diameter of the cells plus 5%, optionally plus 2%.

In an embodiment, the first jig comprises an end stop arranged to constrain the axial position of the cells within the location features. Optionally, step b) comprises pushing each of the cells against the end stop after placing the respective cell into the location feature.

Optionally, in step g), the adhesive joins each of the cells in the second group to at least one of the cells in the first group. This ensures that all of the cells within the set are securely connected to at least two other cells.

According to an aspect of the invention for which protection is sought, there is provided a method of manufacture of a battery module comprising:
manufacturing first and second sets of mechanically connected cylindrical cells, wherein each set of mechanically connected cylindrical cells is manufactured according to a method as claimed in any preceding claim;
connecting a respective busbar assembly to each of the first and second sets of mechanically connected cylindrical cells, wherein the busbar assemblies are located proximate the first ends of the cells in the respective set and are arranged to electrically connect the plurality of cells in each set in parallel, thereby to create first and second sub-assemblies;
positioning the first and second sub-assemblies within a housing; and
electrically connecting the busbar assemblies of the first and second sub-assemblies, such that the cells in the first sub-assembly are electrically connected to the cells in the second sub-assembly in series.

According to an aspect of the invention for which protection is sought, there is provided a method of manufacture of a vehicle, comprising manufacturing a battery module as described above or a set of mechanically connected cylindrical cells as described above, and further comprising installing the battery module or the set of mechanically connected cylindrical cells within the vehicle.

According to an aspect of the invention for which protection is sought, there is provided a battery module manufactured according to a method as described above.

According to an aspect of the invention for which protection is sought, there is provided a battery pack comprising a plurality of battery modules as described above.

According to an aspect of the invention for which protection is sought, there is provided a vehicle comprising a battery module or a battery pack as described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIGS. 1A-C show different views of a cylindrical cell that may be used in a vehicle battery module (PRIOR ART);

FIG. 2 shows a group of cylindrical cells mechanically bonded together according to an embodiment of the present invention;

FIG. 3A shows a first jig for use in a method of manufacture of a set of mechanically connected cells according to an embodiment of the present invention;

FIG. 3B shows a cross sectional view through of the jig shown in FIG. 3A;

FIG. 3C shows the jig shown in FIGS. 3A and 3B when in use;

FIG. 3D shows an alternative embodiment of the first jig shown in FIGS. 3A-C;

FIG. 4 shows a second jig for use in a method of manufacture of a set of mechanically connected cells according to an embodiment of the present invention;

FIGS. 5A-D show cross sections through the jig shown in FIG. 4 at different stages of the manufacture of a group of mechanically bonded cylindrical cells;

FIG. 6 shows an alternative embodiment of the second jig shown in FIGS. 4 and 5A-D;

FIG. 7 shows a flow chart illustrating the steps in a method of manufacture of a set of mechanically connected cylindrical cells and subsequent assembly into a battery module in an embodiment of the present invention; and

FIG. 8 shows a vehicle in an embodiment of the present invention.

### DETAILED DESCRIPTION

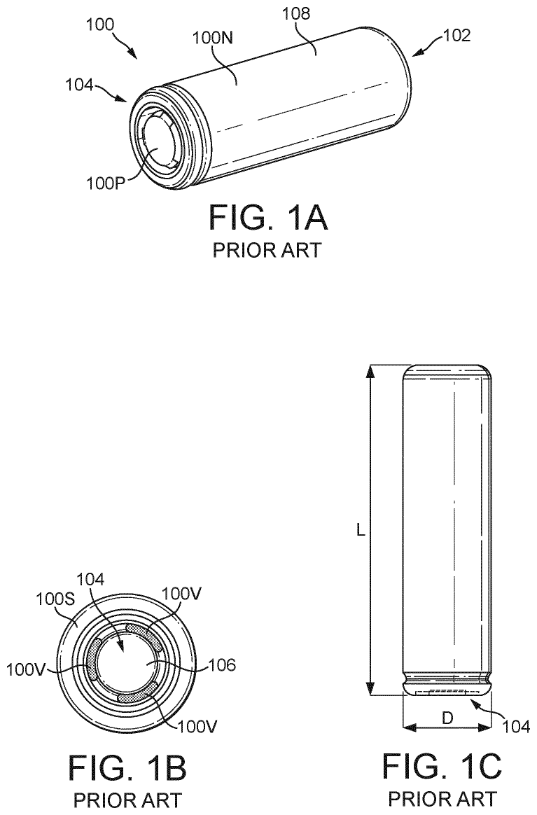

FIGS. 1A-C show different views of a conventional cylindrical cell 100. Cylindrical cells 100 are widely available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used in embodiments of the present invention.

As will be well understood by the skilled person, the cell 100 comprises a positive terminal 100P, a negative terminal 100N, and vent means 100V. The positive terminal is provided by a steel end cap 106 in a central region of the first end 104 of the cell, and the negative terminal is provided by a steel cylindrical case 108. The steel cylindrical case 108 covers the second end 102, the entire cylindrical surface between the first and second ends, and a peripheral region 100S of the first end surface. The peripheral region of the first end surface may also be referred to as a “shoulder” region 100S of the first end surface 104. In commercially-available cells, the end cap that defines the positive terminal 100P on the first end surface 104 sometimes protrudes beyond the shoulder region 100S of the first end surface, although this is not the case in the cell shown in FIG. 1.

The positive terminal protruding beyond the shoulder region 100S allows a substantially planar connector to be connected to the positive terminal and not the negative terminal. As will be well understood by the skilled person, it is important to avoid direct electrical connections between the positive and negative terminals, as such connections create a short circuit which may damage the cell.

As shown in FIG. 1, the cell 100 comprises three vent means 100V in the first end surface 104, between the steel end cap 106 that defines the positive terminal 100P and the shoulder region 100S of the steel cylindrical case 108. The vent means 100V are gaps that are covered by a material that will rupture to allow hot gases to escape through the gap between the end cap 106 and steel cylindrical case 108 in the event of excessive pressure occurring inside the cell, thereby mitigate against the risk of the cell exploding.

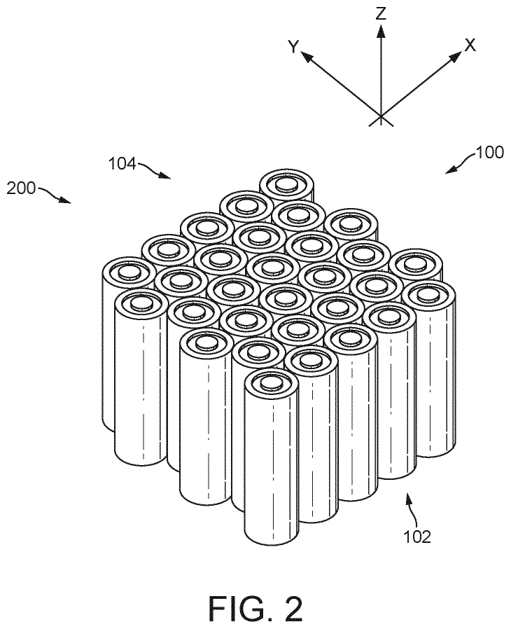

FIG. 2 shows a block 200 comprising a plurality of cylindrical cells 100 mechanically joined together via an adhesive on the cylindrical surfaces of the cells 100. At its narrowest point, the adhesive has a thickness of 0-0.5 mm, preferably 0.2-0.4 mm. It will be understood that the diameter of the cells is not controlled to a very high dimensional tolerance. Accordingly, the thickness of the layer of adhesive between adjacent cells may vary depending upon the actual dimensions of the cells, and this variation may help to mitigate the effects of the dimensional tolerance of the cells 100 on the overall dimensional tolerance of the block 200.

The block 200 shown in FIG. 2 comprises 30 cylindrical cells arranged in a common orientation and in a side-to-side configuration. The block comprises six rows of five cells, each row being offset from the adjacent rows by a distance approximately equal to the radius of one of the cylindrical cells, thereby improving the efficiency with which the cells can be packaged into a given volume. It will be understood that other configurations of the block 200 are also useful, and that the block may comprise more or fewer cells in different embodiments.

The adhesive layer between the cells 100 in the block 200 has a relatively high electrical resistance. As such, whilst the cells 100 in the block 200 are mechanically joined together, the cylindrical surfaces (which form part of the negative terminal of the cells) are not likely to be electrically connected to one another. However, as will be explained in more detail below, when the blocks 200 are assembled to form part of a battery module, the cells within each block will all be electrically connected together in parallel. Accordingly, it is perfectly acceptable for electrical connections to be present between the cylindrical surfaces of some or all of the cells within the block 200.

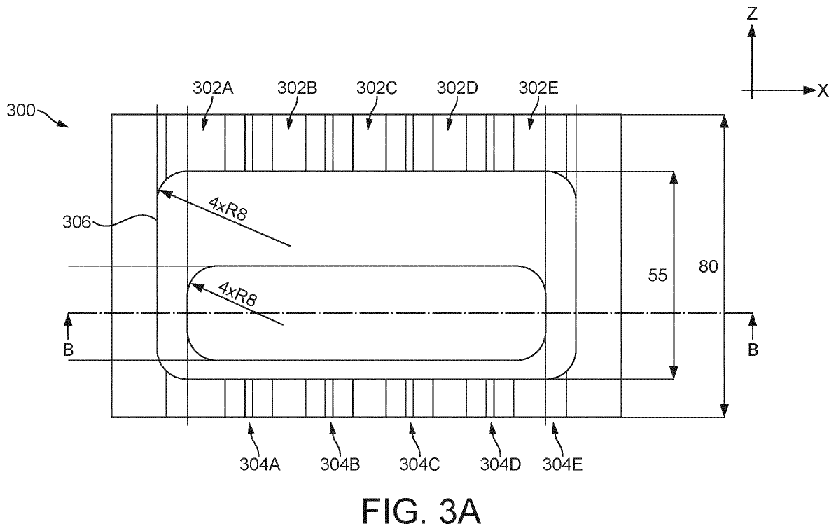

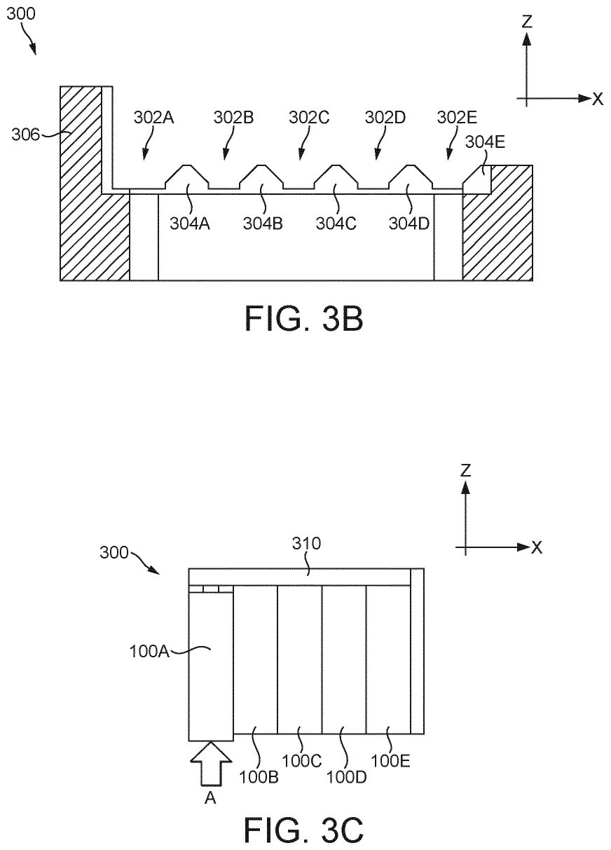

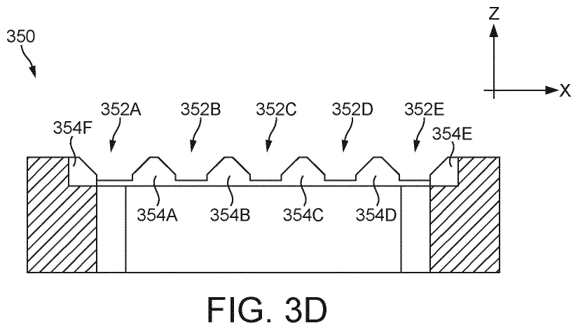

FIG. 3A shows a first jig 300 for use in a method of mechanically joining a block 200, or set 200, of cells 100, and FIG. 3B shows a cross section through the jig 300 taken along line B-B. A jig might otherwise be termed a fixture by those skilled in the art.

FIG. 3A shows a first view of a jig 300 for use in a first stage of the process of mechanically joining a group of cells 200 as shown in FIG. 2, and FIG. 3B shows a cross section through the jig 300 taken along line B-B. In the first stage of manufacture of a group of cells 200 as shown in FIG. 2, six separate rows of five cells are mechanically joined together using a suitable adhesive. The first jig 300 is used for mechanically joining these rows of five cells.

Jig 300 comprises first to fifth cell location features 302A-E, at which respective cells 100 can be laid. The adjacent cell location features are separated from one another by raised formations 304A-E. When a cell is laid in the first location feature, the cylindrical surface 108 of the cell abuts the wall 306 and the first one of the raised formations 304A. At each of the other four location features, the cylindrical surfaces 108 of the cells 100 abut two of the raised formations 304A-E. When the cylindrical surface 108 of a cell 100 abuts two of the raised formations, the position of the centreline of the cell 100 is fixed to a relatively fine tolerance. In particular, the position of the centreline in the X direction substantially coincides with the centre of the cell location feature 302B-E, which is equidistant between the two adjacent raised formations. Accordingly, the overall length of a row of cells 100 produced in the first jig 300 is equal to the distance from the wall 306 to the centre of the fifth cell location feature 302E, plus the radius of the cell in the fifth location feature 302E. This helps to alleviate the problem of tolerance stack, as the variation in overall length depends only on the dimensional tolerance of the cell in the fifth location 302E. Once in the jig 300, the cells may be joined by manually or automatically applying beads of adhesive connecting the cells.

The distances between the cell location features 302A-E are selected such that the cylindrical surfaces of the cells are very close and can be joined by a thin layer of adhesive. For example, the distance between the centres of adjacent location features for a jig used in joining cylindrical cells having a diameter of 21 mm may be 21.3 mm.

Although not visible in FIG. 3A, the first jig 300 is also provided with an end stop 310 as shown in FIG. 3C, which helps to ensure correct positioning of the cells in the cell location features 302A-E along the Z axis shown in FIGS. 3A and 3C, in order to constrain the axial position of the cells. Accurate positioning of the cells along the Z axis is achieved by first placing the cell into the respective location feature such that it does not touch the end stop 310, as is the case for the cell 100A shown in FIG. 3C. The cell is subsequently pushed against the end stop 310 in the direction illustrated by the arrow A in FIG. 3C. This ensures that all of the cells 100A-E are in abutment with the end stop 310 before the application of adhesive to the cells. In the embodiment of FIG. 3C the first end surfaces 104 of the cells are arranged to abut the end stop 310, but in some configurations the second end surfaces 102 of the cells are arranged to abut the end stop 310.

In another embodiment the first end surfaces 104 of the cells are pressed against the end stop 310 by a pusher plate (not shown) configured to push against the second end surfaces 102 of the cells. The pusher plate is put in place once all the cells are loaded into the location features. The pusher plate lies parallel to the end stop 310 and comprises a series of resiliently mounted abutments for engaging with the second end surfaces 102 so that a substantially constant pushing force acts on the cells to ensure they are all contacting the end stop 310 during the subsequent gluing operation. The resilient mounting of the pusher plate also accommodates minor differences in the lengths of the cells whilst enabling application of the pushing force.

The application of the adhesive may be performed manually or by an automated process. In either event, a linear bead of adhesive is applied along the junction between two adjacent cells. For embodiments not comprising a pusher plate then in order to prevent the application of the adhesive bead from dragging the cells away from their position along the Z axis, the adhesive is applied along the junctions in the positive Z direction, such that any forces applied to the cells by the application of adhesive simply act to force the cells against the end stop 310 (which the cells are already in abutment with). The length of the bead of adhesive may be between 25% and 90% of the total length of the cells being joined, and is preferably about 50% of the total length of the cells. Preferably the adhesive is not applied adjacent to the first end of the cells, as any adhesive in this region could potentially interfere with the electrical connections between the cells and the busbar that will be connected to the group of cells 200 once it has been completed. It will be understood that the “junction” between neighbouring cells is the region at which the cylindrical surfaces most closely approach one another. The cylindrical surfaces will not typically be in direct contact at the junction, although they will be close enough together that a bead of adhesive will be able to bridge the gap between the neighbouring cells and form a strong bond.

The wall 306 shown in the embodiment discussed above with respect to FIGS. 3A-C is optional and so may be replaced by a raised formation 354F as shown in FIG. 3D. FIG. 3D shows a cross-sectional view through an alternative embodiment of the first jig 350. In FIG. 3D, the cell location features 352A-E are separated from one another by raised formations 354A-E in the manner of FIGS. 3A-C, but when a cell is laid in the first location feature 354A, the cylindrical surface 108 of the cell abuts the first two of the raised formations 354F and 354A.

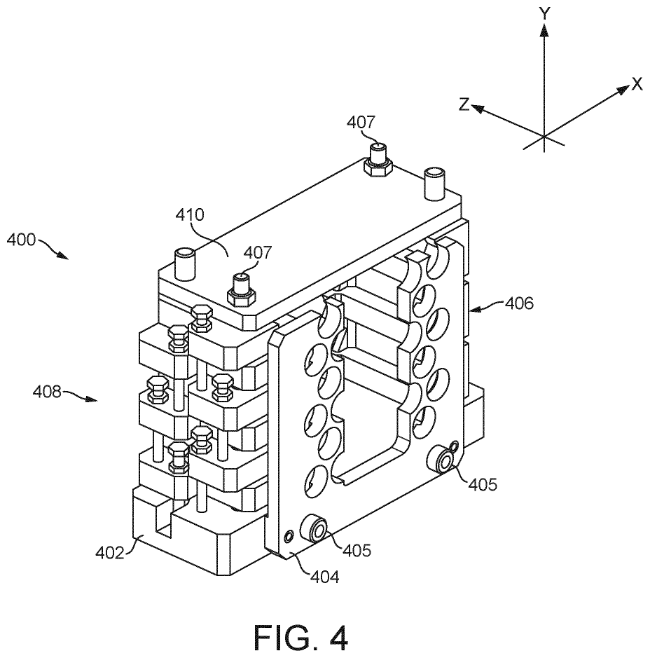

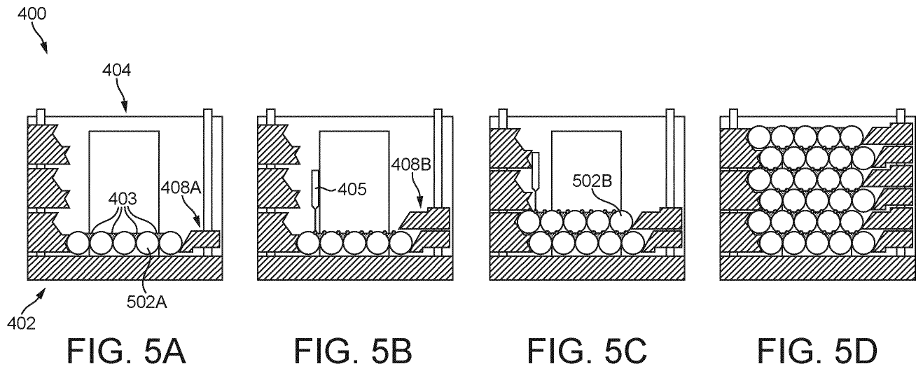

Once six rows of five cells have been mechanically joined using the first jig 300, 350, these rows may be joined together using a second jig, as will be described in more detail below with respect to FIGS. 4 and 5.

The second jig 400 comprises a base 402 having an end plate 404 attached thereto via bolts 405. The end plate 404 is arranged to provide a planar surface that the first end surfaces 104 or the second end surfaces 102 of the cells within the rows of cells that were manufactured in the first jig 300, 350 can abut during the step of joining the rows of cells in the second jig 400. The second jig 400 also comprises first and second abutment features 406, 408, which are arranged to abut the cylindrical surfaces of the outermost cells within each of the rows during the step of joining the rows of cells in the second jig. As will be described in more detail below with respect to FIGS. 5A-D, the first abutment feature comprises an assembly which is split into six distinct removable parts, which allows parts of the first abutment feature to be added as the manufacture of the group of cells within the second jig 400 progresses. Once all of the rows of cells are in place within the jig 400 and the first and second abutment features are fully assembled, a top plate 410 is secured in place on top of the cells and the abutment features, by bolts 407.

As shown in FIG. 5A, the jig 400 is initially assembled with all of the first abutment assembly in place, but only a first component 408A of the second abutment assembly 408 in place. The end plate 404 is also attached to the base 402. These components are sufficient to constrain the position of a first row of cells 502A in the X and Z directions, such that a second row of cells 502B may be placed above the first row of cells 502A in a predetermined relative position, as shown in FIG. 5C.

Prior to the placement of the second row of cells 502B, elongated beads 403 of adhesive are applied onto the first row of cells along lines where the cells within the first row of cells 502A will contact the second row of cells 502B when it is in place, as shown in FIG. 5B. These elongated beads are applied along the Z direction, starting approximately ¼ of the way along the cell from the second end, and extending approximately ½ of the total length of the cell. The beads of adhesive are by a robot-controlled applicator 405 in the illustrated embodiment, but in some embodiments they may be applied manually. In either event, the beads are preferably applied in the positive Z direction (i.e. moving towards the end plate 404), to ensure that any drag forces imparted onto the row of cells 502A only act to force the cells against the end plate 404, and do not move the row of cells out of position. A second component 408B is also attached to the second abutment assembly 408 prior to the placement of the second row of cells 502B. As can be seen from FIG. 5B, it is necessary to put the second component 408B in place after the placement of the first row of cells 502A, because the second component 408B would otherwise interfere with the placement of the first row of cells 502A.

As shown in FIG. 5C, the second row of cells 502B is placed on top of the first row of cells 502A. In order to maximise the cell density, the second row is offset from the first row in the X direction by a distance equal to half the distance between adjacent cells within the rows of cells; that is by a distance equal to half the diameter of the cells plus half of the separation distance between adjacent cells. Accordingly, in the illustrated embodiment the offset in the Y direction is 10.65 mm (=(21 mm+0.3 mm)/2).

Subsequent rows of cells are placed on top of the first and second rows of cells one at a time, in a similar manner to the placement of the second row of cells. When the sixth and final row of cells is in place, no further layers of adhesive are applied, and the second jig 400 is closed by securing the top plate 401 over the top of the existing rows of cells. The adhesive is then allowed to cure, thereby to form a group of mechanically connected cells 200, as shown in FIG. 2.

The first and second jigs 300, 400 ensure correct positioning of the cells 100 within the group 200, and help to mitigate the problem of tolerance stack on the overall dimensional tolerance of the group of cells 200. Accordingly, a battery module may be constructed from several groups of cells 200. Preferably, a busbar assembly is provided that connects the cells 100 within a given one of the groups 200 in parallel, and that also connects each group in series with one or more other groups.

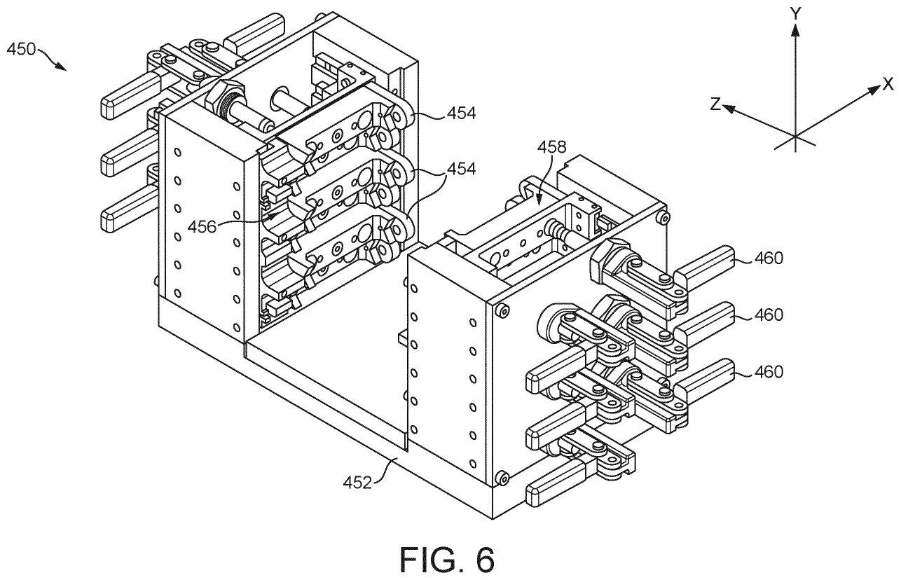

An alternative embodiment of the second jig 450 is shown in FIG. 6, and comprises a base 452 and first and second abutment features 456, 458, which are arranged to abut the cylindrical surfaces of the outermost cells within each of the rows during the step of joining the rows of cells in the second jig 450. The first and second abutment features each comprise an assembly which is split into six distinct movable parts, which allows the parts of the first and second abutment feature to be moved so as to grip each row of cells as the manufacture of the group of cells within the second jig 450 progresses. Hand clamps 460 comprising resilient elements are used to apply the movement of each part of the abutment features. Once all of the rows of cells are in place within the jig 450 and the parts of the first and second abutment features are fully clamped then the adhesive is allowed to cure.

In FIG. 6 the parts of each abutment feature comprise an end plate 454 which is arranged to provide a surface that the first end surfaces 104 or the second end surfaces 102 of the cells within the rows of cells can abut.

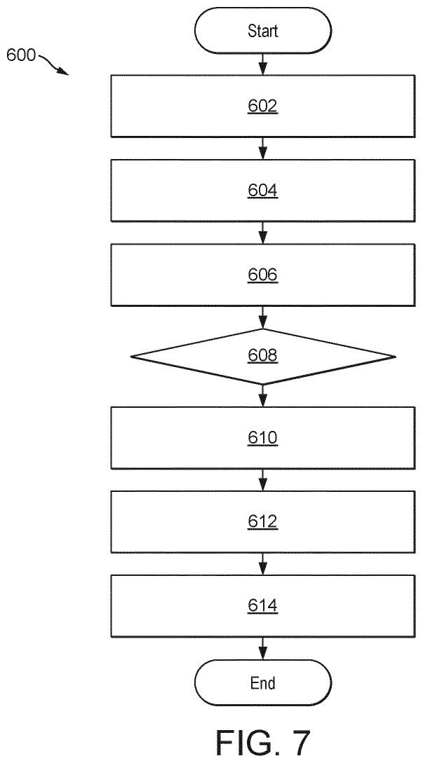

FIG. 7 shows a method 600 for manufacturing a set of mechanically connected cylindrical cells 200 in an embodiment of the present invention.

The method begins at step 602, in which a first jig having a plurality of spaced apart cell location features is provided. The first jig may be a jig 300 as shown in FIGS. 3A-C. Each location feature is preferably arranged to constrain a cylindrical cell placed therein such that the longitudinal axes of the cells in the location features are substantially parallel and coplanar. The method then proceeds to step 604, in which a plurality of cylindrical cells are placed in adjacent location features, as illustrated in FIG. 3C.

Once the cells are in place within the location features, the method proceeds to step 606, in which adjacent cells are mechanically bonded together using beads of adhesive to produce a first row of cells.

The method then proceeds to step 608, in which it is determined whether or not enough rows of cells have been produced. If there are not yet enough rows of cells, then the method returns to step 602, at which the production of another row of cells begins.

Although FIG. 7 shows the rows of cells being made sequentially, it will be understood that in some embodiments several first jigs 300, 350 may be provided, and all of the required rows of cells may be made simultaneously in different jigs.

If there are enough rows of cells in step 608, then the method proceeds to step 610, in which the first row of cells is placed into a second jig, which may be a jig 400 as shown in FIGS. 4 and 5, or as shown in FIG. 6.

The method then proceeds to step 612, in which one or more beads of adhesive is applied to the first row of cells or a second row of cells. The second row of cells is then placed into the jig in step 614, such that the adhesive joins the first and second rows of cells.

After step 614, the method may end, in which case the set of mechanically connected cells is complete after the adhesive has cured, However, in some embodiments more than two rows of cells may be provided, in which case at least one bead of adhesive may be applied on top of the second row of cells or onto a third row of cells, and the third row of cells may subsequently be placed on top of the second row of cells. The method may continue in this manner, with further beads of adhesive and rows of cells being applied on top of the uppermost row of cells until the requisite number of rows have been added. For example, FIGS. 4 and 5 show a second jig 400 in which first to sixth rows of cells are placed. A similar jig 450 is also shown in FIG. 6.

The content of the steps shown in FIG. 7 are listed in Table 1.

| Step | Description |
|---|---|
| 602 | Provide a first jig having a plurality of cell location features |
| 604 | Place a plurality of cells in adjacent cell location features |
| 606 | Join adjacent cells with beads of adhesive |
| 608 | Enough rows of cells? |
| 610 | Place first row of cells in second jig |
| 612 | Apply one or more beads of adhesive to first or second row of cells |
| 614 | Place second row of cells into second jig |

After all of the rows of cells have been placed within the jig, a closure may be placed over the cells to ensure that they do not move while the adhesive is curing.

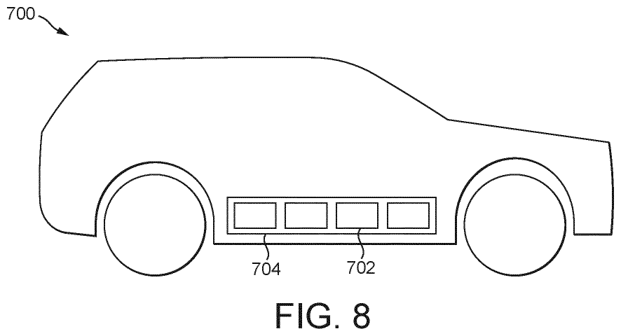

FIG. 8 shows a vehicle 700, into which a battery module 702 according to one or more embodiments of the present invention may be incorporated. In some embodiments, the vehicle may comprise a battery pack, or vehicle traction battery, 704 including a plurality of battery modules according to embodiments of the present invention.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of manufacture of a set of mechanically connected cylindrical cells, the method comprising:
a) providing a first jig having a plurality of spaced apart cell location features, wherein each cell location feature is arranged to constrain a cylindrical cell placed therein such that the longitudinal axes of the cells in the location features are substantially parallel and coplanar;
b) placing a plurality of cylindrical cells in adjacent location features;
c) mechanically bonding adjacent cells with adhesive to produce a first row of cells;
d) repeating steps b)-c) to produce a second row of cells;
e) placing the first row of cells into a second jig such that the longitudinal axes of the cells in the first row are located in a first plane;
f) applying adhesive to one of the first and second rows of cells; and
g) placing the second row of cells into the second jig adjacent to the first row of cells, such that the longitudinal axes of the cells in the second row are located in a second plane parallel to the first plane, and such that the adhesive joins the first and second rows of cells.

2. The method as claimed in claim 1, wherein the second jig comprises a first set of abutment features arranged to constrain the position of the first row of cells in the first plane and a second set of abutment features arranged to constrain the position of the second row of cells in the second plane.

3. The method as claimed in claim 1, wherein step b) comprises placing at least five cells in adjacent location features.

4. The method as claimed in claim 1, wherein step d) comprises repeating steps b)-c) at least five times, to produce second, third, fourth, fifth and sixth rows of cells.

5. The method as claimed in claim 1, wherein the adjacent cell location features are spaced apart by a distance of less than the diameter of the cells, plus 1 mm.

6. The method as claimed in claim 5, wherein the adjacent cell location features are spaced apart by a distance of less than the diameter of the cells, plus 0.5 mm.

7. The method as claimed in claim 1, wherein the first jig comprises an end stop arranged to constrain the axial position of the cells within the location features.

8. The method as claimed in claim 7, wherein step b) comprises pushing each of the cells against the end stop after placing the respective cell into the location feature.

9. The method as claimed in claim 1, wherein in step g), the adhesive joins each of the cells in the second group to at least one of the cells in the first group.

10. A method of manufacture of a battery module comprising:
manufacturing first and second sets of mechanically connected cylindrical cells, wherein each set of mechanically connected cylindrical cells is manufactured according to the method as claimed in claim 1;
connecting a respective busbar assembly to each of the first and second sets of mechanically connected cylindrical cells, wherein the busbar assemblies are located proximate the first ends of the cells in the respective set and are arranged to electrically connect the plurality of cells in each set in parallel, thereby to create first and second sub-assemblies;
positioning the first and second sub-assemblies within a housing; and
electrically connecting the busbar assemblies of the first and second sub-assemblies, such that the cells in the first sub-assembly are electrically connected to the cells in the second sub-assembly in series.

11. A method of manufacture of a vehicle, comprising manufacturing the battery module according to the method as claimed in claim 10, and further comprising installing the battery module within the vehicle.

12. A battery module manufactured according to the method of claim 1.

13. A battery pack comprising a plurality of battery modules as claimed in claim 12.

14. A vehicle comprising the battery module as claimed in claim 12.

15. A vehicle comprising the battery pack as claimed in claim 13.

16. A method of manufacture of a vehicle, comprising manufacturing a set of mechanically connected cylindrical cells according to the method as claimed claim 1, and further comprising installing the set of mechanically connected cylindrical cells within the vehicle.
